(19) United States
(12) Patent Application Publication
(10) Pub. No.: US 2026/0360377 A1
(43) Pub. Date: Nov. 12, 2026

(54) METHOD AND DEVICE FOR DISCONTINUOUS TRANSMISSION IN AN OBJECT-BASED AUDIO CODEC

(71) Applicant: VOICEAGE CORPORATION, Town of Mount Royal (CA)

(72) Inventor: Vaclav EKSLER, Brno (CZ)

(21) Appl. No.: 19/125,926

(22) PCT Filed: Nov. 14, 2023
(86) PCT No.: PCT/CA2023/051518

§ 371 Date: Apr. 30, 2025

Related U.S. Application Data
(60) Provisional application No. 63/426,535, filed on Nov. 18, 2022.

(51) Int. Cl. G10L 19/06; H04W 76/28

(52) U.S. Cl. CPC G10L 19/06; H04W 76/28

(57) ABSTRACT

A method and device for discontinuous transmission (DTX) of audio objects in an object-based audio codec, the audio objects including respective audio streams, comprises an analyser of the audio streams for producing voice or signal activity information on the audio objects. A DTX controller detects, in response to the activity information on the audio objects, a DTX signal segment of the audio objects and a SID frame within the DTX signal segment. The DTX controller (a) updates a global SID counter of inactive frames, and (b) signals the SID frame within the DTX signal segment depending on a value of the global SID counter. An encoder encodes the SID frame. In a device for decoding audio objects during discontinuous transmission (DTX) operation, the audio objects each including an audio stream with metadata (MD) including at least one MD parameter, a metadata decoder for decodes the metadata and adjusts values of the MD parameter to lower differences in the MD parameter between frames, and an audio stream decoder decodes the audio streams.

### TECHNICAL FIELD

The present disclosure relates to sound coding, in particular but not exclusively to a method and device for discontinuous transmission (DTX) in an object-based audio codec.

In the present disclosure and the appended claims:
(a) The term “audio” may be related to speech, music and any other sound.
(b) The term “multichannel” may be related to two or more channels.
(c) The term “stereo” is an abbreviation for “stereophonic”.
(d) The term “mono” is an abbreviation for “monophonic”.
(e) The term “object-based audio” is intended to represent an auditory scene as a collection of individual elements, also known as audio objects. Also, “object-based audio” may comprise, for example, speech, music and any other sound including general audio sound.
(f) The term “audio object” is intended to designate an audio stream with associated metadata. For example, in the present disclosure, an “audio object” is referred to as an independent audio stream with metadata (ISM).
(g) The term “audio stream” is intended to represent, in a bit-stream, an audio waveform, for example speech, music and/or any other sound including general audio sound, and may consist of one channel (mono) although multi-channels including two channels (stereo) might be also considered.
(h) The term “metadata” is intended to represent a set of information describing for example an audio stream and an artistic intension used to translate the original or coded audio objects to a reproduction system. The metadata usually describes spatial properties of each individual audio object, such as position, orientation, volume, width, etc. As a non-limitative example, in the context of the present disclosure, two sets of metadata are considered:
   input metadata: unquantized metadata representation used as an input to a codec; the present disclosure is not restricted a specific format of input metadata; and
   coded metadata: quantized and coded metadata forming part of a bit-stream transmitted from an encoder to a decoder.
(i) The term “audio format” is intended to designate an approach to achieve an immersive audio experience.
(j) The term “reproduction system” is intended to designate an element, in a decoder, capable of rendering audio objects, for example but not exclusively in a 3D (Three-Dimensional) audio space around a listener using the transmitted metadata and artistic intension at the reproduction side. The rendering can be performed to a target loudspeaker layout (for example 5.1 surround) or to headphones while the metadata can be dynamically modified, for example in response to feedback from a head-tracking device. Other types of rendering may be contemplated.

### BACKGROUND

Discontinuous transmission (DTX) is used in mobile communication systems to switch a radio transmitter off during speech or general audio pauses. The use of DTX saves power in the mobile station and increases the time required between battery recharging. It also reduces the general interference level and thus improves transmission quality. During speech or general audio pauses, however, the background noise that is typically transmitted with the speech or general audio also disappears if the channel is completely cut off. The result is an unnatural sounding audio signal (silence) at the receiving end of the communication.

Instead of completely switching the transmission off during speech or general audio pauses, a number of techniques have been developed in which parameters that characterize the background noise are generated and sent in a Silence Insertion Descriptor (SID) frames bit-stream at a low bitrate. These parameters, often referred to as Comfort Noise (CN) parameters, can then be used at the receiver side (decoder) to regenerate background noise respecting, as much as possible, the spectral and temporal content of the background noise at the transmitter side (encoder). The process to regenerate the background noise is known as the Comfort Noise Generation (CNG).

Historically, conversational telephony has been implemented with mono handsets having only one transducer to output sound only to one of the user's ears. Consequently, the SID of mono codecs can achieve a low bitrate. In the last decade, users have started to use their portable handset in conjunction with a headphone to receive the sound over their two ears mainly to listen to music but also, sometimes, to listen to speech. Nevertheless, when a portable handset is used to transmit and receive conversational speech, the content is still mono but presented to the user's two ears when a headphone is used.

With the 3GPP (3rd Generation Partnership Project) speech coding standard implementing a Codec for Enhanced Voice Services (EVS) as described in Reference [1], of which the full content is incorporated herein by reference, the quality of the coded audio sound, for example speech, music and any other sound that is transmitted and received through a portable handset has been significantly improved. The next natural step is to transmit stereo information such that the receiver gets as close as possible to a real-life audio scene that is captured at the other end of the communication link.

Further, in last years, the generation, recording, representation, coding, transmission, and reproduction of audio is moving towards enhanced, interactive and immersive experience for the listener. The immersive experience can be described, for example, as a state of being deeply engaged or involved in an audio scene while sounds are coming from all directions. In immersive audio (also called 3D (Three-Dimensional) audio), the sound image is reproduced in all three dimensions around the listener, taking into consideration a wide range of sound characteristics like timbre, directivity, reverberation, transparency and accuracy of (auditory) spaciousness. Immersive audio is produced for a particular audio playback or reproduction system such as loudspeaker-based-system, integrated reproduction system (sound bar) or headphones. Then, interactivity of an audio reproduction system may include, for example, an ability to adjust sound levels, change positions of sounds, or select different languages for the reproduction.

There are three fundamental approaches (also referred below as audio formats) to achieve an immersive audio experience.

A first approach is a channel-based audio where multiple spaced microphones are used to capture sounds from different directions while one microphone corresponds to one audio channel in a specific loudspeaker layout. Each recorded channel is supplied to a loudspeaker in a particular location. Examples of channel-based audio comprise, for example, stereo, 5.1 surround, 5.1+4 etc.

A second approach is a scene-based audio (SBA) which represents a desired sound field over a localized space as a function of time by a combination of dimensional components. The signals representing the scene-based audio are independent of the sound sources positions while the sound field has to be transformed to a chosen loudspeakers layout at the rendering reproduction system. An example of scene-based audio is ambisonics.

A third, last immersive audio approach is an object-based audio which represents an auditory scene as a set of individual audio elements (for example singer, drums, guitar) accompanied by information about, for example their position in the audio scene, so that they can be rendered at the reproduction system to their intended locations. This gives an object-based audio a great flexibility and interactivity because each object is kept discrete and can be individually manipulated.

Beyond the fundamental approaches, new multi-channel coding techniques are being developed such as Metadata-Assisted Spatial Audio (MASA) as described for example in Reference [5] of which the full content is incorporated herein by reference. In the MASA approach, the MASA metadata (for example direction, energy ratio, spread coherence, distance, surround coherence, all in several time-frequency slots) are generated in a MASA analyzer, quantized, coded, and passed into the bit-stream while MASA audio channel(s) are treated as (multi-)mono or (multi-)stereo transport signals coded by the core encoder(s). At the MASA decoder, MASA metadata then guide the decoding and rendering process to recreate an output spatial sound.

Each of the above-described audio approaches to achieve an immersive experience presents pros and cons. It is thus common that, instead of only one audio approach, several audio approaches are combined in a complex audio system to create an immersive auditory scene. An example can be an audio system that combines scene-based audio (SBA) or MASA with object-based audio, for example SBA or MASA with a few discrete audio objects.

In recent years, 3GPP started working on developing a 3D audio codec for immersive services called IVAS (Immersive Voice and Audio Services) as described in Reference [2] of which the full content is incorporated herein by reference, based on the EVS codec as described in Reference [1]. The IVAS codec is a multi-channel codec where the bitrate is usually more demanding with the increased number of coded and transmitted channels.

The DTX operation in multi-channel codec thus needs to address a trade-off between (a) keeping the SID bitrate low and (b) using a high number of channels to be represented. If, for example, each of the channels would be represented by its own SID, the overall codec SID bitrate would be too high. Consequently, there is a need for efficient DTX method and SID coding.

### SUMMARY

According to a first aspect, the present disclosure relates to a method for discontinuous transmission (DTX) of audio objects in an object-based audio codec, the audio objects including respective audio streams, comprising: analysing the audio streams for producing voice or signal activity information on the audio objects; detecting, in response to the activity information on the audio objects, a DTX signal segment of the audio objects and a SID frame within the DTX signal segment, wherein the segment and frame detection comprises (a) updating a global SID counter of inactive frames, and (b) signaling the detected SID frame within the DTX signal segment depending on a value of the global SID counter; and encoding the signaled, detected SID frame using SID frame coding.

According to another aspect, the present disclosure is concerned with a device for discontinuous transmission (DTX) of audio objects in an object-based audio codec, the audio objects including respective audio streams, comprising: an analyser of the audio streams for producing voice or signal activity information on the audio objects; a DTX controller for detecting, in response to the activity information on the audio objects, a DTX signal segment of the audio objects and a SID frame within the DTX signal segment, wherein the DTX controller (a) updates a global SID counter of inactive frames, and (b) signals the detected SID frame within the DTX signal segment depending on a value of the global SID counter; and an encoder of the signaled, detected SID frame using SID frame coding.

According to a further aspect, the present disclosure describes a method for decoding audio objects during discontinuous transmission (DTX) operation, the audio objects each including an audio stream with metadata (MD) including at least one MD parameter, comprising: decoding the metadata comprising adjusting values of the MD parameter to lower differences in the said MD parameter between frames; and decoding the audio streams.

According to a fourth aspect, the present disclosure discloses a device for decoding audio objects during discontinuous transmission (DTX) operation, the audio objects each including an audio stream with metadata (MD) including at least one MD parameter, comprising: a metadata decoder for decoding the metadata, wherein the metadata decoder adjusts values of the MD parameter to lower differences in the said MD parameter between frames; and an audio stream decoder for decoding the audio streams.

The foregoing and other objects, advantages and features of (a) the method and device for discontinuous transmission (DTX) of audio objects in an object-based audio codec and (b) the method and device for decoding audio objects during discontinuous transmission (DTX) operation will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a schematic block diagram illustrating concurrently the DTX transmission method and device implemented in an ISM encoder and corresponding ISM encoding method;

FIG. 2 is a flow chart illustrating a SID/DTX logic used in the DTX transmission method and device implemented in the ISM encoder and corresponding ISM encoding method of FIG. 1;

FIG. 3 is a non-limitative example of structure of a SID bit-stream in an object-based audio codec;

FIG. 4 is a schematic block diagram illustrating concurrently an ISM decoder and corresponding ISM decoding method;

FIG. 5 is a graph of an example of metadata (azimuth) adjustment in DTX operation; and

FIG. 6 is a simplified block diagram of an example configuration of hardware components forming (a) the method and device for discontinuous transmission (DTX) of audio objects in an object-based audio codec, (b) the ISM encoding method and encoder, (c) the method and device for decoding audio objects during discontinuous transmission (DTX) operation, and/or (d) the ISM decoding method and decoder.

### DETAILED DESCRIPTION

The present disclosure describes the method and device for discontinuous transmission (DTX) of audio objects in an object-based audio codec and the method and device for decoding audio objects during discontinuous transmission (DTX) operation.

Non-restrictive illustrative embodiments of the method and device for discontinuous transmission (DTX) of audio objects in an object-based audio codec and the method and device for decoding audio objects during discontinuous transmission (DTX) operation as described hereinafter involves concepts such as identification of inactive signal segments, decision about coding SID frames and associated CN parameters, and coding, quantization, and restoring metadata in inactive signal segments in an object-based audio codec.

In the present disclosure, the method and device for discontinuous transmission (DTX) of audio objects in an object-based audio codec and the method and device for decoding audio objects during discontinuous transmission (DTX) operation will be described, by way of non-limitative example only, with reference to an IVAS coding framework referred to throughout the present disclosure as IVAS codec (or IVAS audio codec). Specifically, the following IVAS formats make the reference: ISM format, OMASA format, and OSBA format. However, it is within the scope of the present disclosure to incorporate such DTX technique in any other audio codec supporting object-based audio.

### 1. Introduction

As a non-limitative example, the present disclosure considers a framework that supports simultaneous coding of several audio objects (for example up to 4 audio objects) while a fixed constant codec total bitrate is considered for coding the audio objects, including the audio streams with their associated metadata. It should be noted that the metadata are not necessarily transmitted for at least some of the audio objects, for example in the case of non-diegetic content. Non-diegetic sounds in movies, TV shows and other videos are sounds that the characters cannot hear. Soundtracks are an example of non-diegetic sound, since the audience members are the only ones to hear the music.

The present disclosure also considers a basic non-limitative example of input metadata consisting of two metadata (MD) parameters, namely azimuth and elevation, which are stored per audio frame for each audio object. In this example, an azimuth range of [−180°, 180°), and an elevation range of [−90°, 90° ], are considered. However, it is within the scope of the present disclosure to consider only one or more than two (2) MD parameters with various ranges.

### 2. Object-Based Coding

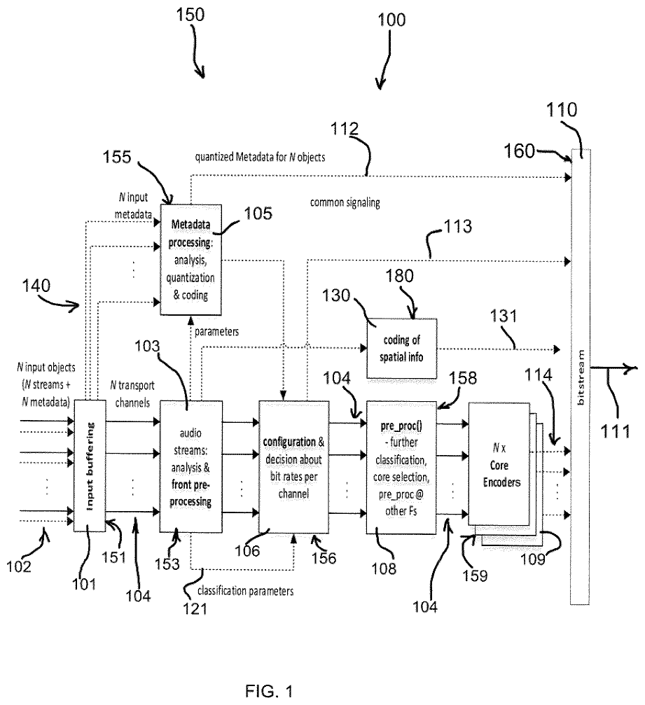

FIG. 1 is a schematic block diagram illustrating concurrently the method 150 and device 100 for discontinuous transmission (DTX) of audio objects in an object-based audio codec implemented within an ISM encoding method and corresponding ISM encoder.

### 2.1 Input Buffering

Referring to FIG. 1, the ISM encoding method comprises an operation of input buffering 151. To perform the operation 151 of input buffering, the ISM encoder comprises an input buffer 101.

The input buffer 101 buffers a number N of input audio objects 102, i.e. a number N of audio streams with the associated respective N metadata. The N input audio objects 102, including the N audio streams and the N metadata associated to each of these N audio streams are buffered for one frame, for example a 20 ms long frame. As well known in the art of audio signal processing, the audio signal is sampled at a given sampling frequency and processed by successive blocks of these samples called “frames” each divided into a number of “sub-frames.”

### 2.2 Audio Streams Analysis and Front Pre-Processing

Still referring to FIG. 1, the DTX transmission method 150 comprises an operation of analysis and front pre-processing 153 of the N audio streams. To perform the operation 153, the DTX transmission device 100 comprises an audio stream processor (analyser) 103 to analyze and front pre-process, for example sequentially, the buffered N audio streams transmitted from the input buffer 101 to the audio stream processor (analyser) 103 through a number N of transport channels 104, respectively.

The analysis and front pre-processing operation 153 performed by the audio stream processor (analyser) 103 may comprise, for example, at least one of the following sub-operations: time-domain transient detection, spectral analysis, long-term prediction analysis, pitch tracking and voicing analysis, voice or signal activity detection (VAD/SAD), bandwidth detection, noise estimation and signal classification (which may include in a non-limitative embodiment (a) core-encoder selection between, for example, ACELP core-encoder, TCX core-encoder, HQ core-encoder, etc., (b) signal type classification between, for example, inactive core-encoder type, unvoiced core-encoder type, voiced core-encoder type, generic core-encoder type, transition core-encoder type, and audio core-encoder type, etc., (c) speech/music classification, etc.). Information obtained from the analysis and front pre-processing operation 153 is supplied to a configuration and decision processor 106 through a line 121. Examples of the foregoing sub-operations are described in Reference [1] in relation to the EVS codec and, therefore, will not be further described in the present disclosure.

### 2.2.1 DTX/CNG Operation Overview

As indicated herein above, discontinuous transmission (DTX) and comfort noise generation (CNG) are used in the method 150 and corresponding device 100 to reduce the transmission bitrate by simulating background noise during inactive signal periods. In the EVS codec as described in Reference [1], a regular DTX/CNG scheme is supported for bitrates up to 24.4 kbps. For higher bitrates, the EVS codec supports a less aggressive DTX/CNG scheme that only switches to comfort noise generation (CNG) for low input signal power.

The reduction of the transmission bitrate during inactive signal periods is achieved by coding the parameters referred to as comfort noise (CN) parameters. The CN parameters can be transmitted at a fixed or adaptive bitrate during inactive signal periods. As an example, in the EVS codec as described in Reference [1], a default transmission rate of CNG update (aka SID update rate) is set to 8 frames.

When the EVS codec is operated with the DTX/CNG scheme, a signal activity detector (SAD) is used to analyze the input audio signal to determine whether the input audio signal is active or inactive (see SAD decision in subclause 5.1.12 of Reference [1]). Based on its analysis, the SAD detector generates a SAD flag, f_{SAD}, whose state indicates whether the input audio signal is active (f_{SAD}=1) or merely a background noise (f_{SAD}=0). When the flag f_{SAD}=1, regular encoding and decoding is performed, as in the default option. When f_{SAD}=0, DTX functions are run at the encoder that transmit either a Silence Insertion Descriptor (SID) frame or a NO_DATA frame. In the following description, the frames where the input audio signal is active (f_{SAD}=1) are called “active frames” and the frames with merely background noise (f_{SAD}=0) are called “inactive frames”.

The SID frame contains the CN parameters, which are used to update the characteristics of the background noise at the decoder, whereas the NO_DATA frame is empty. The SID frame in EVS is always encoded using 48 bits (which corresponds to the bitrate of 2.4 kbps).

As indicated herein above, the multichannel IVAS codec is based on the EVS codec. Specifically, a variable bitrate version of the EVS encoder is employed as the so-called core-encoder. The SID bitrate of the core-encoder in IVAS is the same as the SID bitrate of EVS, i.e. 2.4 kbps, while the CNG algorithms of the EVS codec are reused in the core-encoder of the IVAS codec as much as possible.

In general, the number of core-encoders in IVAS is one up to the number of input audio channels (i.e. every audio channel is coded by an associated core-encoder). In case of the ISM format, the number of core-encoders N is usually equal to the number N of independent audio streams with metadata (ISMs) and it is then called “discrete ISM” coding. It should be noted that “parametric ISM” techniques can be also employed where the number of core-encoders is less than the number of audio objects. These “parametric ISM” techniques are usually employed at low bitrates where active channel coding of all audio objects is not possible due to bitrate constraints.

It is obvious that coding all ISMs in an SID frame would result in N times (2.4 kbps+metadata) bitrate which would further result in too high an IVAS SID bitrate. In order to keep it reasonably low, the IVAS SID bitrate is set to 5.2 kbps and efficient coding of SID frames is introduced.

### 2.2.2 Classification of Inactive Frames in ISM Encoder

As indicated herein above, the audio stream processor (analyser) 103 analyzes the audio streams conveyed by respective channels 104 from the input buffer 101, classifies the input audio objects and produces the voice or signal activity detection (VAD/SAD) flag f_{SAD}, one per audio object. A change from f_{SAD}=1 to f_{SAD}=0 indicates a start of inactive signal segment for a particular audio object. Several VAD/SAD flag variants can be used, for example a “local VAD” flag as described in Paragraph 5.1.12 of Reference [1]. It is obvious that the start of an inactive signal segment usually happens at different time instances in different audio objects.

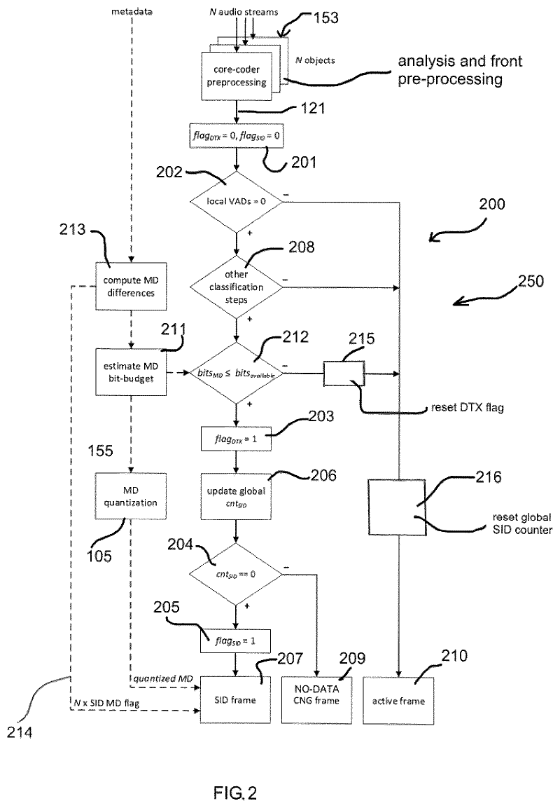

By default, in an object-based audio system a DTX signal segment is declared when an inactive signal segment is declared for all audio objects. Then, additional classification stages are used to classify the inactive signal segments. Also, the values of metadata have an impact whether a frame is declared as an inactive frame. The classification logic of inactive (SID or NO_DATA) frames or active frames is illustrated in FIG. 2.

### 2.2.3 Global SID Counter, DTX Flag, SID Flag

FIG. 2 is a flow chart illustrating concurrently a DTX control operation 250 and corresponding DTX controller 200 used in the DTX transmission method 150 and device 100 implemented in the ISM encoder and corresponding ISM encoding method of FIG. 1.

Referring to FIG. 2, in order to control the SID/NO_DATA frame decision and the start of a DTX signal segment, the DTX controller 200 uses a global SID counter cnt_{SID} of inactive frames. This global SID counter cnt_{SID} allows to control the SID update rate and synchronize the SID/NO_DATA frames across all audio objects. Consequently, the global SID counter cnt_{SID} enables efficient tuning of a potential hang-over (hysteresis) DTX logic, or permits other than a default SID update rate of, for example, 8 frames or SID adaptive update rate.

In the disclosed logic, the global SID counter cnt_{SID} (parameter “cnt_SID_ISM” in the source code at the end of the present disclosure) is thus superior to per audio object SID counters and it effectively ensures that the individual per audio object SID counters are synchronized.

Referring to FIG. 2, the DTX controller 200 receives the information from line 121 obtained from the analysis and pre-processing operation 153, including the VAD information. The DTX controller 200 then initializes to “0” the DTX flag flag_{DTX} and the SID flag flag_{SID} (block 201).

By default, the DTX controller 200 detects a DTX signal segment (SID or NO_DATA frame) of the audio objects when the VAD flags flag_{VAD} of all audio objects are equal to 0 (block 202). The DTX controller 200 signals (block 203) that the VAD flags flag_{VAD} of all audio objects are equal to 0 by setting the DTX flag flag_{DTX}=1 (parameter ‘dtx_flag’ in the source code at the end of the present disclosure). This can be expressed using relation (1):

$${flag}_{DTX} = \{ \begin{matrix}1 & if local VAD = 0 & for all audio objects \\ 0 & otherwise & \end{matrix} \qquad ( 1 )$$

where flag_{DTX} is, as mentioned earlier, the DTX flag. When the VAD flags flag_{VAD} of all audio objects are not equal to 0 (block 202), the DTX controller 200 signals an active frame (block 210) and selects active frame coding.

Further, the DTX controller 200 signals SID frames within the DTX signal segment using a SID flag flag_{SID} (parameter ‘sid_flag’ in the source code at the end of the present disclosure). The SID flag flag_{SID} is set (a) to 1 (block 205) when the global SID counter cnt_{SID} equals to 0 (block 204) in which case the DTX controller 200 signals a SID frame (block 207) within the DTX signal segment and selects SID frame coding of the signaled SID frame and (b) to 0 when the global SID counter cnt_{SID} does not equal to 0 (block 204) in which case the DTX controller 200 signals a NO_DATA frame (block 209) within the DTX signal segment and selects NO_DATA frame coding of the signaled NO_DATA frame. This can be expressed using relations (2):

$${flag}_{SID} = \{ \begin{matrix}1 & if {cnt}_{SID} = 0 \\ 0 & otherwise\end{matrix} \qquad ( 2 )$$

In block 206 of FIG. 2, the DTX controller 200 resets the SID counter cnt_{SID} to −1 in every active frame and it is incremented by 1 at every inactive frame up to the value corresponding to the SID update rate (by default 8 frames in the above example of implementation). If the value of counter cnt_{SID} reaches the SID update rate, it is reset to 0 and the DTX controller 200 signals a SID frame (blocks 204, 205 and 207) within the DTX signal segment and selects SID frame coding of the signaled SID frame.

The DTX controller 200 can alter the DTX flag flag_{DTX} by using other classification stages (block 208) based on core-encoder pre-processing values for all audio objects.

As a non-limitative example, the DTX controller 200 may comprise a logic that forces active frame coding (flag_{DTX}=0) and selection of active frame coding (block 210) in cases when 1) a mean value of the LT (Long-Term) background noises over all audio objects, noiseₘₑₐₙ, is higher than a first threshold β₁, or 2) the mean value of LT background noises over all audio objects, noiseₘₑₐₙ, is higher than a second threshold β₂ and LT background noise variations over all audio objects, noise_varₘₑₐₙ, is higher than a third threshold β₃. This can be expressed using relation (3):

flag_{DTX}=0 if noiseₘₑₐₙ>β₁ or (noiseₘₑₐₙ>β₂ and noise_varₘₑₐₙ>β₃) (3)

The thresholds are found experimentally and can be set e.g. to β₁=50, β₂=10, and β₃=2. The introduction of the assessment of the LT background noise variations is introduced in order to check for background noise similarities among all audio objects. The parameter noiseₘₑₐₙ represents the mean value of the long-term background noise energy values of all audio objects (see Paragraph 5.1.11 in Reference [1]). The parameter noise_varₘₑₐₙ then represents the variation of the long-term background noise energy values of all audio objects.

Also, a similar logic as in the EVS codec is used in the IVAS codec; for higher bitrates, the IVAS codec supports a less aggressive DTX/CNG scheme that only switches to CNG for low input signal power.

As another non-limitative example of decision about an inactive signal segment, the DTX controller 200 comprises a logic that assesses the energy of background noise in all audio channels 104 (audio streams). Typically, when there is one audio object with a high-energy dominant background noise and other audio objects have low-energy background noises, the DTX flag is set to 1 (flag_{DTX}=1) otherwise it is set to 0 (flag_{DTX}=0) which means that DTX is not triggered (active frame coding (block 210) is selected) when there are more than one audio object with a high-energy noise.

### 2.3 Metadata Analysis, Quantization and Coding

The ISM encoding method of FIG. 1, for coding the object-based audio signal further comprises an operation of metadata analysis, quantization and coding 155. To perform the operation 155, the ISM encoder for coding the object-based audio signal comprises a metadata processor 105.

The analysis, quantization and coding of metadata in non-DTX operation can be done, for example, as described in Reference [3], of which the full content is incorporated herein by reference. It is noted that the metadata processor 105 of FIG. 1 quantizes and codes the metadata 140 of the N audio objects 102, in the described non-restrictive illustrative embodiments, sequentially in a loop while a certain dependency can be employed between quantization of audio objects and the metadata parameters of these audio objects.

As indicated herein above, in the present disclosure, two metadata parameters, azimuth and elevation (as included in the N input metadata), are considered in the example implementation. As a non-limitative example, the metadata processor 105 comprises a quantizer (not shown) of the following metadata parameter indices using the following example resolution to reduce the number of bits being used:
Azimuth parameter: A 12-bit azimuth parameter index from a file of the input metadata is quantized to a B_{az}-bit index (for example B_{az}=7). Giving the minimum and maximum azimuth limits (−180 and +180°), a quantization step for a (B_{az}=7)-bit uniform scalar quantizer is 2.835°.
Elevation parameter: A 12-bit elevation parameter index from the input metadata file is quantized to a Bₑₗ-bit index (for example Bₑₗ=6). Giving the minimum and maximum elevation limits (−90° and +90°), a quantization step for a (Bₑₗ=6)-bit uniform scalar quantizer is 2.857°.

Both azimuth and elevation parameter indices, once quantized, can be coded by a metadata encoder (not shown) of the metadata processor 105 using either absolute or differential coding (112 in FIG. 1). As known in the art, absolute coding means that a current value of a parameter is coded. Differential coding means that a difference between a current value and a previous value of a parameter is coded. As the indexes of the azimuth and elevation parameters usually evolve smoothly (i.e. a change in azimuth or elevation position can be considered as continuous and smooth), differential coding is used by default as it often consumes less bits compared to absolute coding.

### 2.3.1 Metadata Analysis, Quantization and Coding in SID Frames

As indicated herein above, the bit-budget in SID frames is relatively low. In case of the IVAS codec, the SID bitrate is 5.2 kbps from which roughly one half is reserved for a metadata (MD) payload. In order to transmit as much as possible MD values, some compromises are made.

The present disclosure is based on forcing the MD coding by the metadata encoder (not shown) of the metadata processor 105 in SID frames to the absolute coding method. It is noted that this is different from the MD coding in active frames where absolute/differential coding is employed. The motivation to use solely the absolute coding in SID frames is to avoid potential degradation in long segments of inactive frames due to a lost SID frame in case of a noisy channel if differential coding would be used.

Then, one possibility to match the bit-budget constraints is to lower the resolution of MD values. However, this would mean that the MD reconstruction at the decoder will not be precise enough causing subjective quality degradation. The present disclosure thus introduces several mechanisms to overcome these constraints.

First, the DTX controller 200 makes resolution of MD values dependent on the number of audio objects. Specifically, when the number of audio objects is low, the available bit-budget for coding the metadata (MD) is relatively generous and the MD resolution is thus kept relatively high (for example the same as in the active frames). On the other hand, when the number of coded audio objects is high, the resolution of MD values is relatively low.

In an example implementation, where azimuth and elevation MD parameters are considered, the metadata processor 105 is set-up to encode:
a) azimuth and elevation indexes, for example, by means of B_{az}=8 bits and Bₑₗ=7 bits in a system with one or two audio objects,
b) azimuth and elevation indexes, for example, by means of B_{az}=6 bits and Bₑₗ=5 bits in a system with three or four audio objects,
   while the actual number of coded bits and thus the resolution is explicitly known from the ISM common signaling (see 113 of FIG. 1 and Paragraph 2.8 below).

Second, in order to keep the SID bit-budget as low as possible, a saving in MD bit-budget is achieved by computing a flag, one flag per audio object, indicating that the MD parameters have not changed (or has not changed significantly) since the last frame and consequently that the metadata (MD) parameters for a specific audio object are not coded and transmitted. Similarly, this flag serves as an indication that the input MD parameters are not present for that specific audio object.

Referring back to FIG. 2, in an example implementation, the DTX controller 200 computes a MD on/off flag, flag_{MD} (parameter ‘diff_flag’ in the source code at the end of the present disclosure) for all MD parameter values (block 213). For example, a flag flag_{MD,θ} is calculated for the azimuth MD parameter using the following relation (4):

$${flag}_{MD , θ} = \{ \begin{matrix}1 & if \vert θ - {θ}_{last} \vert > {δ}_{θ} \\ 0 & otherwise\end{matrix} \qquad ( 4 )$$

where θ is the current frame azimuth, θₗₐₛₜ is the last frame azimuth and δ₀ is an azimuth maximum difference value, for example δ_{θ}=15. In the same manner (see relation (4)), the DTX controller (block 213) computes a flag flag_{MD,φ} for the elevation MD parameter (or for any other MD parameters). The final MD on/off flag flag_{MD} for one audio object can be obtained as a logical OR (symbol V in the relation (5) below) between all particular MD flags:

flag_{MD}=flag_{MD,θ}∨flag_{MD,φ}∨ . . . (5)

Finally, the flag flag_{MD} 214 represented as a 1-bit information per audio object, is inserted into the bit-stream in the SID frame 207 right after the ISM signalization of the number N of coded audio objects 301 (see Paragraph 2.8.1 below).

Third, the DTX controller comprises a mechanism (blocks 211 and 212 of FIG. 2) that estimates the bit-budget bits_{MD} for metadata quantization. It should be noted that it is only the bit-budget for the quantization of metadata values which is estimated (computed in advance) at this stage while the quantization itself is possibly performed only later. When the estimated bit-budget bits_{MD} is higher than a maximum available bit-budget for the MD coding, bits_{available}, (block 212) the flag flag_{DTX} is reset to 0 (block 215) and active frame coding (block 210) is performed. On the other hand, when the estimated MD bit-budget, bits_{MD}, is lower or equal to the maximum available bit-budget for the MD coding, bits_{available}, (block 212) the flag flag_{DTX} is not changed and the DTX coding segment continues. While the maximum available bit-budget for the MD coding, bits_{available}, is computed as the difference between the codec SID bit-budget minus the bit-budget needed for other than MD coding (e.g. SID frame signaling, core-encoder SID bit-budget, spatial information bit-budget, ISM signaling) in the SID frame.

This logic comes from premise that CNG frames do not represent important audio details while the metadata (MD) are considered as important details for representing the output audio and thus are transmitted to the decoder. When there are more audio objects, the probability to switch to the active frame coding (block 210) is obviously higher. This logic also becomes even more important when more metadata (other than only azimuth and elevation) are present and to be coded.

### 2.4.1 Bitrates Per Channel Configuration and Decision

Referring to FIG. 1, the ISM encoding method comprises an operation 156 of configuration and decision about bitrates per transport channel 104. To perform the operation 156, the ISM encoder comprises a configuration and decision processor 106 forming a bit-budget allocator.

The configuration and decision processor 106 (herein after bit-budget allocator 106) can use a bitrate adaptation algorithm to distribute the available bit-budget for core-encoding the N audio streams in the N transport channels 104. Details of the bitrate adaptation algorithm to distribute the available bit-budget for core-encoding can be found in Reference [3].

### 2.5 Pre-Processing

Referring to FIG. 1, the ISM encoding method comprises an operation of pre-processing 158 of the N audio streams conveyed through the N transport channels 104 from the configuration and decision processor 106 (bit-budget allocator). To perform the operation 158, the ISM encoder comprises a pre-processor 108.

Once the configuration and bitrate distribution between the N audio streams is completed by the configuration and decision processor 106 (bit-budget allocator), the pre-processor 108 performs sequential further pre-processing 158 on each of the N audio streams. Such pre-processing 158 may comprise, for example, further signal classification, further core-encoder selection (for example selection between ACELP core, TCX core, and HQ core), other resampling at a different internal sampling frequency Fₛ adapted to the bitrate to be used for core-encoding, etc. Examples of such pre-processing can be found, for example, in Reference [1] in relation to the EVS codec and, therefore, will not be further described in the present disclosure.

### 2.6 Core-Encoding

Referring to FIG. 1, the ISM encoding method comprises an operation of core-encoding 159. To perform the operation 159, the ISM encoder 100 comprises, to code the N audio streams, for example a number N of core-encoders 109 to respectively code the N audio streams conveyed through the N transport channels 104 from the pre-processor 108.

Specifically, in the case of active frame coding, the N audio streams are encoded using N fluctuating bitrate core-encoders 109, for example mono core-encoders. The bitrate used by each of the N core-encoders is the bitrate selected by the configuration and decision processor 106 (bit-budget allocator) for the corresponding audio stream. For example, core-encoders based on EVS as described in Reference [1] can be used as core-encoders 109.

In case of DTX operation (SID frame coding), the SID of one audio object is coded by one of the core-encoders 109 while the processing in the other core-encoders 109 can be done in NO_DATA frame operation (they only update the core-encoder state parameters). Alternatively, no processing is performed in the said other core-encoders 109, i.e. pre-processing and core-encoding are completely skipped in the said other core-encoders 109.

### 2.7 Coding of Spatial Information

Referring to FIG. 1, the ISM encoding method comprises an operation 180 of coding spatial information, and the ISM encoder comprises a corresponding coding module 130. The spatial information analyses similarities between audio objects and can be based, for example, on inter-channel cues like inter-channel level difference, or inter-channel coherence.

The spatial information is usually estimated and coded in parametric ISM coding techniques or in SID frames coding. Examples can be found in the IVAS framework described in Reference [4], of which the full content is incorporated herein by reference.

### 2.8 SID Bit-Stream Structure

Referring to FIG. 1, the ISM encoding method comprises an operation of multiplexing 160. To perform the operation 160, the ISM encoder comprises a multiplexer 110.

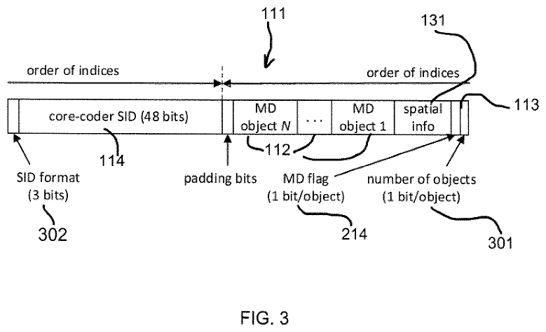

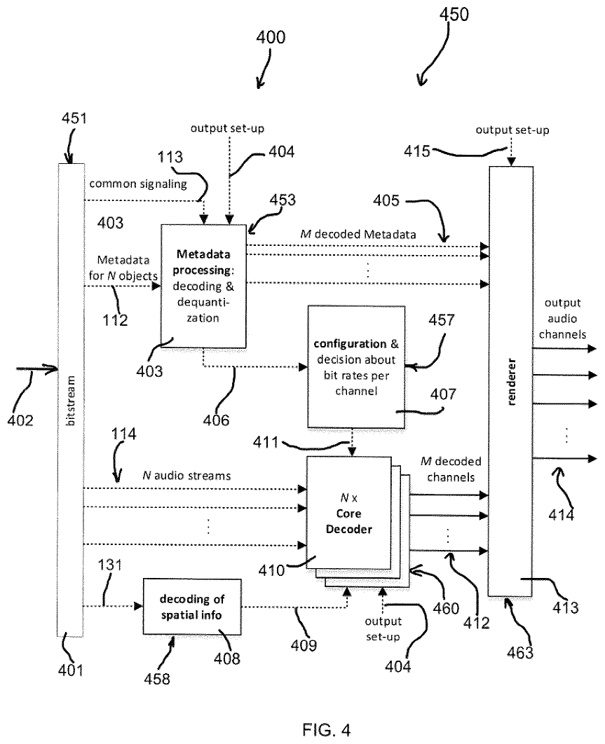

FIG. 3 is a schematic diagram illustrating, for a frame, the structure of the SID bit-stream 111 produced by the multiplexer 110 and transmitted from the ISM encoder of FIG. 1 to the ISM decoder 400 of FIG. 4. Regardless whether metadata are present and transmitted or not, the structure of the SID bit-stream 111 may be structured as illustrated in FIG. 3.

Referring to FIG. 3, the multiplexer 110 writes the indices 302 of SID format signaling followed by the indices 114 of one core-encoder SID from the beginning of the bit-stream 111 while the indices of ISM common signaling 113 from the configuration and decision processor 106 (bit-budget allocator), spatial information 131 from the coding module 130, and metadata 112 from the metadata processor 105 are written from the end of the bit-stream 111.

### 2.8.1 ISM Common Signaling in SID Frame

The multiplexer writes the ISM common signaling 113 from the end of the bit-stream 111. The ISM common signaling in SID frame is produced by the configuration and decision processor 106 (bit-budget allocator) and comprises a variable number of bits representing:
(a) a number N of audio objects: the signaling for the number N of coded audio objects present in the bit-stream 111 is in the form of, for example, a unary code 301 with a stop bit (for example, for N=3 audio objects, the first 3 bits of the ISM common signaling would be “110” written in a backward order).
(b) the metadata on/off flag flag_{MD}, one per audio object, as described in Relation (5) and represented by line 214.

### 2.8.2 Metadata Payload

In a SID frame, right after the ISM common signaling 113, in the backward order, there are written into the bit-stream 111 a) spatial information indices 131, and finally b) metadata values 112 as quantized in Paragraph 2.3.1 above.

### 2.8.3 Audio Streams Payload

In active frames, the multiplexer 110 receives N audio streams 114 coded by N core-encoders 109 through N transport channels 104, and writes it from the beginning of the bit-stream 111 (See FIG. 3) right after the IVAS format bits 302.

In SID frames, the multiplexer 110 receives one audio stream 114 coded by one of the core-encoders 109 through one transport channel 104, and write it from the beginning of the bit-stream 111 (See FIG. 3) right after the IVAS SID format bits 302 (signalization of the SID mode related to the IVAS format).

### 3. Decoding of Audio Objects

FIG. 4 is a schematic block diagram illustrating concurrently an ISM decoding method 450 implementing the method for decoding audio objects during discontinuous transmission (DTX) operation and a corresponding ISM decoder 400 implementing the device for decoding audio objects during discontinuous transmission (DTX) operation.

### 3.1 Demultiplexing

Referring to FIG. 4, the ISM decoding method 450 comprises an operation of demultiplexing 451. To perform the operation 451, the ISM decoder 400 comprises a demultiplexer 401.

The demultiplexer 401 receive a bit-stream 402 transmitted from the ISM encoder of FIG. 1 to the ISM decoder 400 of FIG. 4. Specifically, the bit-stream 402 of FIG. 4 corresponds to the bit-stream 111 of FIG. 1.

The demultiplexer 401 extracts from the bit-stream 402 (a) the coded N audio streams 114 in case of active frame coding, or one audio stream in case of a SID frame, (b) the coded metadata 112 for the N audio objects, (c) the spatial information 131, and (d) the ISM common signaling 113 read from the end of the received bit-stream 402.

### 3.2 Metadata Dequantization and Decoding

Referring to FIG. 4, the ISM decoding method 450 comprises an operation 453 of metadata decoding and dequantization. To perform the operation 453, the ISM decoder 400 comprises a metadata decoding and dequantization processor (metadata decoder) 403.

The metadata decoding and dequantization processor (metadata decoder) 403 is supplied with the coded metadata 112 for the transmitted N audio objects, the ISM common signaling 113, and an output set-up 404 to decode and dequantize the metadata for the audio streams/objects with active contents. The output set-up 404 is a command line parameter about the number M of decoded audio objects/transport channels and/or audio formats, which can be equal to or different from the number N of coded audio objects/transport channels. The metadata decoding and dequantization processor (metadata decoder) 403 produces decoded metadata 405 for the M audio objects/transport channels, and supplies the decoded metadata and information about their respective bit-budgets on line 406. Obviously, the decoding and dequantization performed by the processor (metadata decoder) 103 is the inverse of the quantization and coding performed by the metadata processor 105 of FIG. 1.

### 3.2.1 Metadata Adjustment in DTX Operation

At the ISM decoder 400, the SID frames are received at a certain rate (for example in IVAS, 8 frames by default), resulting in a possibility that received MD parameter values are changed between SID frames with a large step. These large steps can cause subjective artifacts; for example, the positions of the audio objects can change suddenly from one place to another one. In order to avoid these artifacts, the metadata decoding and dequantization processor (metadata decoder) 403 adjusts the MD parameter values at the ISM decoder 400 such that the MD parameter value differences are lowered between frames. For example, an interpolation between the true decoded and dequantized current frame MD parameter value and the previous frame MD parameter value can be applied in certain frames following the SID frame. This results in the MD parameter values evolving more smoothly while the smoothing is applied in several CNG frames, or several active frames, or several CNG and active frames following an SID frame.

As an example, the adjustment, or smoothing, can be applied on each MD parameter such that the maximum difference (step) of a MD parameter between two adjacent frames is not more (lower) than a given threshold. Let's suppose the current decoded and dequantized MD parameter value of azimuth θ_{dec} and the maximum smoothing step for azimuth difference being Δ_{θ}. Then:

$${θ}_{dec} = \{ \begin{matrix}{θ}_{last} + sgn ( {θ}_{true} - {θ}_{last} ) \cdot {Δ}_{θ} & if \vert θ - {θ}_{last} \vert > {Δ}_{θ} \\ {θ}_{true} & otherwise\end{matrix} \qquad ( 6 )$$

where θₜᵣᵤₑ is the transmitted quantized azimuth (quantized MD parameter value in general) in the SID frame and θₗₐₛₜ is the azimuth (MD parameter value in general) in the preceding frame and updated at the end of each frame decoding as θₗₐₛₜ=θ_{dec}. In the example implementation, the azimuth (MD parameter value in general) smoothing step value is Δ_{θ}=5 corresponding to the parameter ‘CNG_MD_MAX_DIFF_AZIMUTH’ in the source code at the end of the present disclosure). Further, the operation sgn(x) in Relation (6) is a mathematical expression

$$sgn ( x ) = \{ \begin{matrix}1 , & if x \geq 0 \\ - 1 & otherwise\end{matrix} \qquad ( 7 )$$

Further, the maximum number of frames to apply the smoothing step can be set to a given threshold value Dₘₐₓ. For example, in an example implementation it is not limited in inactive segments but limited in active segments to Dₘₐₓ=5 frames (constant ‘IVAS_ISM_DTX_HO_MAX’ in the source code at the end of the present disclosure) in the example implementation.

Moreover, the smoothing step is skipped in active frames when the absolute value of the difference between the current frame quantized MD parameter value θₜᵣᵤₑ and the previous frame decoded MD parameter value θₗₐₛₜ is higher than the smoothing step value Δ_{θ} multiplied by the threshold value Dₘₐₓ. For example, in case of the azimuth parameter, it means that:

if |θₜᵣᵤₑ−θₗₐₛₜ|>Dₘₐₓ·Δ_{θ} then skip the smoothing (8)

Relation (8) also applies to MD parameters other than azimuth. Relation (8) is used to prevent wrong smoothed MD parameter estimation when the true values of a MD parameter are changing significantly from frame to frame and the number of frames between the last SID frame and the active frame is low (in general lower than Dₘₐₓ).

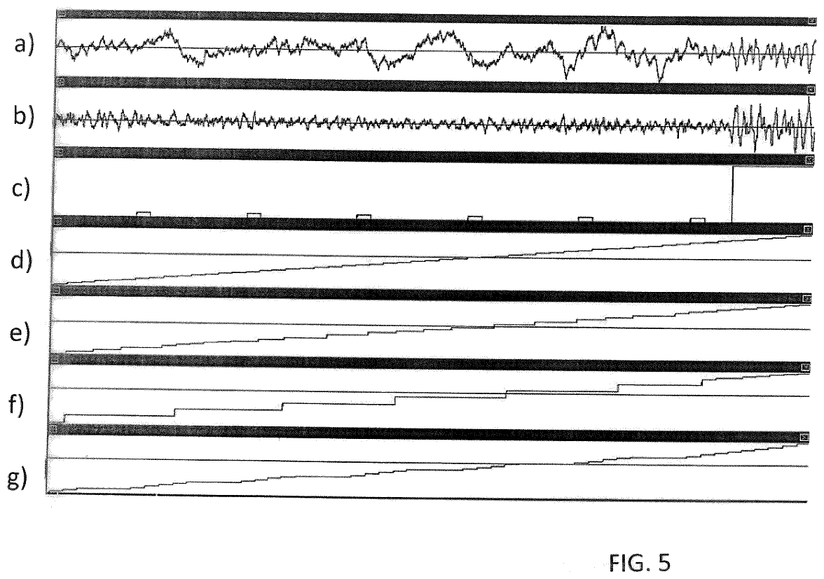

The effect of the smoothing can be seen from the graph of FIG. 5 for the MD azimuth parameter of the first audio object when coding two audio objects in the DTX operation in the IVAS codec. From top to bottom, for a 1.1 second segment, there is a) noisy segment of input audio signal, b) CNG synthesis, c) IVAS total bitrate indicating active frame (48 kbps), SID frames (5.2 kbps), and NO_DATA frames (0 bps), d) encoder input azimuth, e) decoder (quantized) azimuth in case of active frames coding (no DTX), f) decoder azimuth in CNG segment without smoothing, g) decoder azimuth in CNG segment with smoothing.

3.3 Configuration and Decision about Bitrates

Referring to FIG. 4, the ISM decoding method 450 comprises an operation 457 of configuration and decision about bitrates per channel. To perform the operation 457, the ISM decoder 400 comprises a configuration and decision processor 407 (bit-budget allocator).

The bit-budget allocator 407 receives the information about the respective bit-budgets for the M decoded metadata on line 406 to determine the core-decoder bitrates per audio stream. The bit-budget allocator 407 uses the same procedure as in the bit-budget allocator 106 of FIG. 1 to determine the core-decoder bitrates (see section 2.4). In case of SID frame, the core-decoder SID bitrate is assigned to one core-decoder while bitrate of 0 kbps is assigned to the other core-decoders. Obviously, in case of NO_DATA frame, the bitrate of 0 kbps is assigned to all core-decoders.

### 3.4 Decoding of Spatial Information

Referring to FIG. 4, the ISM decoding method 450 comprises an operation of decoding of spatial information 458. The ISM decoder 400 comprises a spatial information decoding module 408 to perform operation 458.

Operation 458 is responsible for decoding of spatial information 409 used in parametric ISM techniques or in SID frames. The decoding 458 is the inverse of the coding 180 of FIG. 1.

### 3.5 Core-Decoding

Still referring to FIG. 4, the ISM decoding method 450 comprises an operation of core-decoding 460. To perform the operation 460, the ISM decoder 400 comprises a decoder of the N audio streams 410 including a number N of core-decoders 410, for example N fluctuating bitrate core-decoders.

The N audio streams 114 from the demultiplexer 401 are decoded, for example sequentially decoded in the number N of fluctuating bitrate core decoders 410 at their respective core-decoder bitrates 411 as determined by the bit-budget allocator 407. When the number of decoded audio objects, M, as requested by the output set-up 404 is lower than the number of transport channels, i.e. M<N, a lower number of core-decoders 410 are used. Similarly, not all metadata payloads may be decoded in such a case.

In response to the N audio streams 114 from the demultiplexer 401, the core-decoder bitrates 411 as determined by the bit-budget allocator 407, and the output set-up 404, the core-decoders 410 produces a number M of decoded audio streams 412 on respective M transport channels.

In case of the SID frame, one audio stream 114 from the demultiplexer 401 is decoded and fed to one of the core-decoders 410. The other core-decoders 410 are fed by the SID of the first core-encoder and spatial information 409.

### 3.6 Audio Channels Rendering

The ISM decoding method 450 might comprises an operation of audio channels rendering 463. To perform operation 463, the ISM decoder 400 comprises a renderer 413 of audio objects.

The renderer 413 transforms the M decoded metadata 405 and the M decoded audio streams 412 into a number of output audio channels 414, taking into consideration an output set-up 415 indicative of the number and contents of output audio channels to be produced. Again, the number of output audio channels 414 may be equal to or different from the number M.

The renderer 413 may be designed in a variety of different structures to obtain the desired output audio channels. For that reason, the renderer is not further described in the present disclosure.

### 4. Example Configuration of Hardware Components

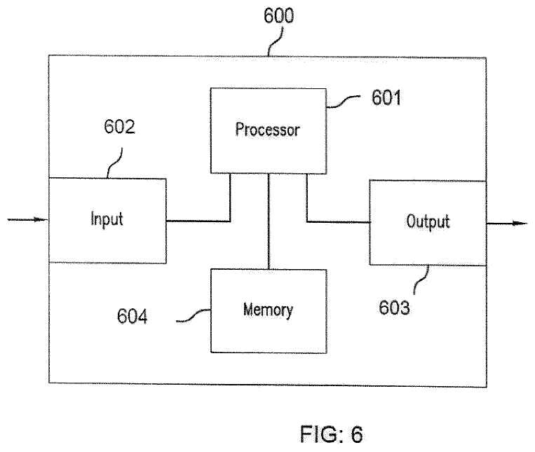

FIG. 6 is a simplified block diagram of an example configuration of hardware components forming (a) the method and device for discontinuous transmission (DTX) of audio objects in an object-based audio codec, (b) the ISM encoding method and encoder, (c) the method and device for decoding audio objects during discontinuous transmission (DTX) operation, and/or (d) the ISM decoding method and decoder (hereinafter collectively the “encoding and decoding methods and devices”).

The encoding and decoding methods and devices may be implemented as a part of a mobile terminal, as a part of a portable media player, or in any similar device. The encoding and decoding methods and devices (identified as 600 in FIG. 6) comprises an input 602, an output 603, a processor 601 and a memory 604.

The input 602 is configured to receive the input signal(s). The output 603 is configured to supply the output signal(s). The input 602 and the output 603 may be implemented in a common module, for example a serial input/output device.

The processor 601 is operatively connected to the input 602, to the output 603, and to the memory 604. The processor 601 is realized as one or more processors for executing code instructions in support of the functions of the various elements and operations of the above described encoding and decoding methods and devices as shown in the accompanying figures and/or as described in the present disclosure.

The memory 604 may comprise a non-transient memory for storing code instructions executable by the processor 601, specifically, a processor-readable memory storing non-transitory instructions that, when executed, cause a processor to implement the elements and operations of the encoding and decoding methods and devices. The memory 604 may also comprise a random access memory or buffer(s) to store intermediate processing data from the various functions performed by the processor 601.

Those of ordinary skill in the art will realize that the description of the encoding and decoding methods and devices is illustrative only and is not intended to be in any way limiting. Other embodiments will readily suggest themselves to such persons with ordinary skill in the art having the benefit of the present disclosure. Furthermore, the disclosed encoding and decoding methods and devices may be customized to offer valuable solutions to existing needs and problems of encoding and decoding audio signals.

In the interest of clarity, not all of the routine features of the implementations of the encoding and decoding methods and devices are shown and described. It will, of course, be appreciated that in the development of any such actual implementation of the encoding and decoding methods and devices, numerous implementation-specific decisions may need to be made in order to achieve the developer's specific goals, such as compliance with application-, system-, network- and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of audio processing having the benefit of the present disclosure.

In accordance with the present disclosure, the elements, processing operations, and/or data structures described herein may be implemented using various types of operating systems, computing platforms, network devices, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used. Where a method comprising a series of operations and sub-operations is implemented by a processor, computer or a machine and those operations and sub-operations may be stored as a series of non-transitory code instructions readable by the processor, computer or machine, they may be stored on a tangible and/or non-transient medium.

Elements and processing operations of the encoding and decoding methods and devices as described herein may comprise software, firmware, hardware, or any combination(s) of software, firmware, or hardware suitable for the purposes described herein.

In the encoding and decoding methods and devices, the various processing operations and sub-operations may be performed in various orders and some of the processing operations and sub-operations may be optional.

Although the present disclosure has been described hereinabove by way of non-restrictive, illustrative embodiments thereof, these embodiments may be modified at will within the scope of the appended claims without departing from the spirit and nature of the present disclosure.

### 5. References

The present disclosure mentions the following references, of which the full content is incorporated herein by reference:
[1] 3GPP TS 26.445, v.17.0.0, “Codec for Enhanced Voice Services (EVS); Detailed Algorithmic Description”, April 2022.
[2] 3GPP TS 26.250 v 1.0.0, “Codec for Immersive Voice and Audio Services—General overview”, September 2023.
[3] V. Eksler, “Method and System for Coding Metadata in Audio Streams and for Flexible Intra-Object and Inter-Objects Bitrate Adaptation,” Patent Publication US 2022/0238127 A1 dated Jul. 28, 2022.
[4] 3GPP SA4 contribution S4-231233 “High-Level Description of the IVAS Codec Candidate of the “IVAS Codec Public Collaboration””, SA4 meeting #125, Aug. 21-25, 2023, https://www.3gpp.org/ftp/Meetings_3GPP_Sync/SA4/Docs/54-231233.zip
[5] 3GPP SA4 contribution S4-180462, “On spatial metadata for IVAS spatial audio input format”, SA4 meeting #98, Apr. 9-13, 2018, https://www.3gpp.org/ftp/tsg_sa/WG4_CODEC/TSGS4_98/Docs/54-180462.zip

1. A device for discontinuous transmission (DTX) of audio objects in an object-based audio codec, the audio objects including respective audio streams, comprising:
at least one processor; and
a memory coupled to the processor and storing non-transitory instructions that when executed cause the processor to implement:
an analyser of the audio streams for producing voice or signal activity information on the audio objects;
a DTX controller for detecting, in response to the activity information on the audio objects, a DTX signal segment of the audio objects and a silence insertion descriptor (SID) frame within the DTX signal segment, wherein the DTX controller (a) updates a global SID counter of inactive frames, and (b) signals the detected SID frame within the DTX signal segment depending on a value of the global SID counter; and
an encoder of the signaled, detected SID frame using SID frame coding.

2. A discontinuous transmission device as defined in claim 1, wherein the activity information comprises an activity detection flag for each audio objects, and wherein the DTX controller detects a DTX signal segment when the activity detection flags of the audio objects are set to a given value.

3. (canceled)

4. A discontinuous transmission device as defined in claim 1, wherein the DTX controller signals the SID frame detected within the DTX signal segment by setting a SID flag to a given value in response to a certain value of the global SID counter.

5. (canceled)

6. A discontinuous transmission device as defined in claim 1, wherein the DTX controller resets the global SID counter in every active frame.

7. A discontinuous transmission device as defined in claim 1, wherein the DTX controller increments the global SID counter in every inactive frame up to a value corresponding to a SID update rate, and resets the global SID counter when the value corresponding to the SID update rate is reached by the global SID counter.

8. (canceled)

9. A discontinuous transmission device as defined in claim 1, wherein, upon detection of a DTX signal segment, the DTX controller sets a DTX flag to a given value, and wherein the DTX controller alters the DTX flag using additional classification stages of the audio objects.

10. A discontinuous transmission device as defined in claim 9, wherein the additional classification stages compare a mean value of long-term background noises over the audio objects and a mean value of long-term background noise variations over the audio objects to respective thresholds.

11. (canceled)

12. A discontinuous transmission device as defined in claim 1, wherein the audio objects each comprise an audio stream with metadata, and wherein the SID frame encoder comprises a metadata encoder for encoding the metadata of the audio objects using absolute coding.

13. A discontinuous transmission device as defined in claim 1, wherein the audio objects each comprise an audio stream with metadata, and wherein the DTX controller calculates a metadata (MD) flag for each audio object, indicating that MD parameters are unchanged to avoid coding and transmission of the metadata of the audio object by the SID frame encoder and thereby save SID bit-budget.

14. A discontinuous transmission device as defined in claim 1, wherein the audio objects each comprise an audio stream with metadata, and wherein the DTX controller estimates a bit-budget for quantizing the metadata and compares the estimated bit-budget with a bit-budget available for quantizing the metadata to select SID frame coding or active frame coding.

15. A discontinuous transmission device as defined in claim 14, wherein, when the estimated bit-budget is higher than the bit-budget available for quantizing the metadata, the DTX controller selects active frame coding for coding the metadata.

16. A discontinuous transmission device as defined in claim 14, wherein, when the estimated bit-budget is lower than the bit-budget available for quantizing the metadata, the DTX controller selects SID frame coding for coding the metadata.

17. A discontinuous transmission device as defined in claim 1, wherein the audio objects each comprise an audio stream with metadata (MD), and wherein the DTX controller makes a resolution of MD values dependent on the number of audio objects.

18-23. (canceled)

24. A method for discontinuous transmission (DTX) of audio objects in an object-based audio codec, the audio objects including respective audio streams, comprising:
analysing the audio streams for producing voice or signal activity information on the audio objects;
detecting, in response to the activity information on the audio objects, a DTX signal segment of the audio objects and a silence insertion descriptor (SID) frame within the DTX signal segment, wherein the segment and frame detection comprises (a) updating a global SID counter of inactive frames, and (b) signaling the detected SID frame within the DTX signal segment depending on a value of the global SID counter; and
encoding the signaled, detected SID frame using SID frame coding.

25. A discontinuous transmission method as defined in claim 24, wherein the activity information comprises an activity detection flag for each audio objects, and wherein the segment and frame detection comprises detecting a DTX signal segment when the activity detection flags of the audio objects are set to a given value.

26. (canceled)

27. A discontinuous transmission method as defined in claim 24, comprising signaling the SID frame detected within the DTX signal segment by setting a SID flag to a given value in response to a certain value of the global SID counter.

28. (canceled)

29. A discontinuous transmission method as defined in claim 24, comprising resetting the global SID counter in every active frame.

30. A discontinuous transmission method as defined in claim 24, comprising incrementing the global SID counter in every inactive frame up to a value corresponding to a SID update rate, and resetting the global SID counter when the value corresponding to the SID update rate is reached by the global SID counter.

31. (canceled)

32. A discontinuous transmission method as defined in claim 24, wherein, upon detection of a DTX signal segment, the segment and frame detection comprises setting a DTX flag to a given value and altering the DTX flag using additional classification stages of the audio objects.

33. A discontinuous transmission method as defined in claim 32, wherein the additional classification stages compare a mean value of long-term background noises over the audio objects and a mean value of long-term background noise variations over the audio objects to respective thresholds.

34. (canceled)

35. A discontinuous transmission method as defined in claim 24, wherein the audio objects each comprise an audio stream with metadata, and wherein the SID frame encoding comprises encoding the metadata of the audio objects using absolute coding.

36. A discontinuous transmission method as defined in claim 24, wherein the audio objects each comprise an audio stream with metadata, and wherein the segment and frame detection comprises calculating a metadata (MD) flag for each audio object, indicating that MD parameters are unchanged to avoid coding and transmission of the metadata of the audio object and thereby save SID bit-budget.

37. A discontinuous transmission method as defined in claim 24, wherein the audio objects each comprise an audio stream with metadata, and wherein the segment and frame detection comprises estimating a bit-budget for quantizing the metadata and comparing the estimated bit-budget with a bit-budget available for quantizing the metadata to select SID frame coding or active frame coding.

38. A discontinuous transmission method as defined in claim 37, wherein the segment and frame detection comprises, when the estimated bit-budget is higher than the bit-budget available for quantizing the metadata, selecting active frame coding for coding the metadata.

39. A discontinuous transmission method as defined in claim 37, wherein the segment and frame detection comprises, when the estimated bit-budget is lower than the bit-budget available for quantizing the metadata, selecting SID frame coding for coding the metadata.

40. A discontinuous transmission method as defined in claim 24, wherein the audio objects each comprise an audio stream with metadata (MD), and wherein the method comprises making a resolution of MD values dependent on the number of audio objects.

41-47. (canceled)

48. A device for discontinuous transmission (DTX) of audio objects in an object-based audio codec, the audio objects including respective audio streams, comprising:
at least one processor; and
a memory coupled to the processor and storing non-transitory instructions that when executed cause the processor to:
analyse the audio streams for producing voice or signal activity information on the audio objects;
detect, in response to the activity information on the audio objects, a DTX signal segment of the audio objects and a silence insertion descriptor (SID) frame within the DTX signal segment, comprising (a) updating a global SID counter of inactive frames, and (b) signaling the detected SID frame within the DTX signal segment depending on a value of the global SID counter; and
an encoder of the signaled, detected SID frame using SID frame coding.

49-50. (canceled)
